(19) United States
(12) Patent Application Publication
(10) Pub. No.: US 2021/0374695 A1
(43) Pub. Date: Dec. 2, 2021

(54) SYSTEM AND METHOD FOR MONETIZING ASSETS

(71) Applicant: Dean Hanisch, Ottawa (CA)

(72) Inventor: Dean Hanisch, Ottawa (CA)

(21) Appl. No.: 17/335,438

(22) Filed: Jun. 1, 2021

Related U.S. Application Data
(60) Provisional application No. 63/031,920, filed on May 29, 2020.

(51) Int. Cl. G06Q 20/06; G06Q 20/38; G06Q 30/06

(52) U.S. Cl. CPC G06Q 20/065; G06Q 2220/00; G06Q 30/0619; G06Q 20/389

(57) ABSTRACT

The present invention provides a method and system for monetizing a physical asset owned by a seller using an Internet-based platform accessible via a website interface configured to facilitate a transaction between a buyer and the seller, the method comprising the steps of identifying an asset, dividing at least a portion of the asset into one or more shares, and determining a monetary value of each share; submitting the one or more shares for verification by a third party verifier; posting an opportunity for a buyer to acquire a share according to terms and conditions as described in a smart contract, the opportunity being posted by the seller via a seller interface on the website; if the terms and conditions of the smart contract are accepted, an offer for payment is entered by the buyer via a buyer interface. If each available opportunity receives an offer for payment, the offers for payment are accepted by the seller via a seller interface to implement the smart contract and transfer a respective share in the asset to the respective buyer and the transaction is validated by a third party validator and recorded on the blockchain. The terms and conditions described in the smart contract include the monetary value of the share of the asset and the time period for which the share of the asset is held by the buyer, and at the end of the time period, the share of the asset is liquidated by the buyer at an appraised market value as determined at that time.

### CROSS REFERENCE TO RELATED APPLICATIONS

This application claims priority under 35 U.S.C. 119 to U.S. Provisional Application No. 63/031,920, filed May 29, 2020, the disclosure of which is incorporated herein by reference.

### FIELD OF THE INVENTION

The present invention pertains to the field of financial products and in particular to methods for the monetization of physical assets.

### BACKGROUND

In recent years, technology has provided greater access to markets and investment opportunities, leading to a surge in capital for global markets as more people around the globe get connected. However, investing can remain restrictive and risky, especially with the increased levels of uncertainty that are developing in our political landscapes. A changing global political landscape combined with the impacts of climate change, have made markets more reactive and in some industries, volatile, with no end in sight. For example, the volatility in emerging markets like cannabis and biotech can act as a barrier to entry for many investors.

As reported in “Missing Out: Millennials and the Markets” (Ontario Securities Commission, Nov. 27, 2017), among the demographic group of adults under the age of 35, often referred to as “the millennial generation” or “millennials”, 53% have no investments. When surveyed, 84% of millennials said that paying off debt was “extremely” or “very” important to them. A large majority of millennials are putting off investing because they have “other financial priorities” like paying off debt or saving for a down payment on a home. Of the millennials who are not investing, 59% say they aren't investing because they don't understand enough to get started and 57% said they don't invest because they are worried about losing money, while another 30% said they don't trust big banks or investment firms with their money. As of 2012, Canadian households under the age of 35 held over $824 billion in assets.

According to a Gallup poll (https://news.gallup.com/poll/233699/young-americans-wary-investing-stocks.aspx), 52% of American adults under 35 said they owned stocks in the seven years leading up to the financial crisis of 2008. But by 2017/18, only 37% reported owning stocks. By comparison, among Americans over the age of 35, 65% owned stocks before the crash, and 61% after the crash. It becomes clear that the younger generation has had their confidence in markets shaken by the global financial crisis, and they have yet to regain that confidence.

While millennials are still wary of investing opportunities, the Baby Boomer generation is the opposite. The Baby Boomer generation controls roughly 70% of disposable income in the United States. Over the next 20 years, it is expected that Baby Boomers will spend $4.74 trillion, a 58% increase over the previous 20 years. In contrast, spending among millennials is only set to increase by 24% over the same time frame (Venture Capital Review: Issue 29-2013). Bringing new investment products to Boomers is a key opportunity to gain access to this increase in spending. Despite controlling most of the disposable income, according to a 2017 survey by Transamerica Center for Retirement Studies, baby boomers have a median of $164,000 saved for retirement, hardly enough to retire comfortably (“Concerns About Future of Social Security Amplify Workers' Retirement Insecurity”, Transamerica Center for Retirement Studies, Jun. 27, 2018).

In Canada, between 1999 and 2016, median assets for Baby Boomers went up from $327,000 to $607,400. However, median debt also increased from $9,000 to $25,000. The increase in debt is largely mortgage related and the increase in assets was related to real estate (https://www150.statcan.gc.ca/n1/pub/75-006-x/2019001/article/00005-eng.htm). This means that while debt is increasing, so is the value of the assets Baby Boomers own. As the younger generation tries to enter the housing market, supply has been diminished, resulting in significant demand and a price boom.

Baby Boomers control the majority of the wealth, but many face the prospect of an uncomfortable retirement with their current savings. Allowing Boomers to retain their assets while liquidating shares is one way to begin the transfer of wealth to younger generations while allowing Boomers to retire in comfort.

In view of the above, it is clear that there is a considerable opportunity to educate the millennial generation on investing, while providing them with access to new, low-risk, and transparent investment alternatives to traditional markets. There is therefore a need for an investment model that allows for the liquidation of capital that has been locked in assets by offering convenient investment opportunities to potential investors who may not otherwise have access to such investment opportunities. There is also a need for an investment model that provides a way for baby boomers to partially liquidate or free up disposable income.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method for monetizing assets. In accordance with an aspect of the present invention, there is provided a method for monetizing a physical asset owned by a seller using an Internet-based platform accessible via a website interface configured to facilitate a transaction between the seller and at least one buyer, the method comprising the steps of: identifying an asset, dividing at least a portion of the asset into one or more shares of the asset, and determining a monetary value of each of the one or more shares of the asset; submitting the one or more shares for verification by a third party verifier; posting an opportunity for each of the one or more shares, wherein the opportunity is an offer for a buyer to acquire one of the one or more shares of the asset according to terms and conditions as described in a smart contract, each said opportunity being posted by the seller via a seller interface on the website, each said opportunity and associated smart contract being recorded on a blockchain; if the terms and conditions of the smart contract are deemed acceptable by the buyer, receiving an offer for payment from the buyer, the offer for payment being entered by the buyer via a buyer interface on the website; if each available opportunity receives an offer for payment, accepting each said offer for payment from each respective buyer to implement the smart contract and transfer a respective share in the asset to the respective buyer, the offer being accepted by the seller via the seller interface to complete the transaction according to the terms and conditions of the smart contract; and validating the transaction by a third party validator and recording the transaction on the blockchain; wherein the terms and conditions described in the smart contract include the monetary value of the share of the asset and the time period for which the share of the asset is held by the buyer, and wherein at the end of the time period, the share of the asset is liquidated according to the terms and conditions of the smart contract.

In accordance with another aspect of the present invention, there is provided a system for monetizing a physical asset owned by a seller, wherein the system comprises: a memory; a communication interface; one or more processors; and executable code stored in memory, wherein the code, when executed by the one or more processors, causes the one or more processors to carry out the method of the present invention.

### BRIEF DESCRIPTION OF THE DRAWINGS

FIGS. 1 to 3 are flow charts illustrating a method for monetizing an asset, in accordance with embodiments of the present invention.

### DETAILED DESCRIPTION OF THE INVENTION

The term “seller” is used to define a party who adds a physical asset to an opportunity blockchain. The seller may be the owner of the asset, or a party that has custodial responsibility for managing the asset. The seller may be a single entity or a group of entities operating as a single unit. The terms “seller” and “issuer” may be used interchangeably in accordance with the present disclosure.

The term “buyer” is used to define a party who purchases shares in an asset as defined in an opportunity blockchain. The buyer may be a single entity or a group of entities operating as a single unit. The terms “buyer” and “investor” may be used interchangeably in accordance with the present disclosure.

The term “asset” is used to define any physical asset that has monetary value and which may be made available, in its entirety or in part, as an investment opportunity to a buyer/investor.

The term “opportunity” is used to define a potential to purchase an interest in an asset through a smart contract recorded by a blockchain, each unique and controlled by its own terms and conditions as determined by the seller.

The term “opportunity blockchain” is used to define one of the opportunities that serves as a public ledger for the asset that is listed in accordance with the terms and conditions of a smart contract.

The term “smart contract” is used to describe the terms and conditions outlined by the seller that describe the investment opportunity before it is added to the opportunity blockchain, and made available to buyers.

Unless defined otherwise, all technical and scientific terms used herein have the same meaning as commonly understood by one of ordinary skill in the art to which this invention belongs.

In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein.

The present invention provides a platform with which any party who has capital tied up in physical assets may monetize a percentage of the asset's value by offering investment opportunities to interested buyers. The platform provides an avenue to monetize the entire asset or a portion of the asset, according to terms and conditions set out by the seller in a smart contract.

In a preferred embodiment, the platform of the present invention is an Internet-based platform accessible via a website interface configured to facilitate interaction and communication over a computer network between all parties to the transaction, including the buyer, the seller and any other participants in the transaction such as the platform administrator, and third party service providers, including but not limited to appraisers or verifiers of the asset, legal service providers, and insurers. The website interface is also configured to communicate information regarding investment opportunities available via the platform.

The platform provides an online marketplace that brings together different users, including sellers and buyers of investment opportunities, as well as third party service providers such as verifiers, legal services, or other providers of services required to facilitate the transactions and ensure the security of each transaction and the validity of each asset made available in an opportunity. The platform is managed by a system administrator, who oversees the registration of buyers, sellers and third party service providers.

In one embodiment, the platform includes a public website that provides access to a list of the services that are offered through the platform, which includes a browsable listing of investment opportunities, as well as the other resources that would be available to a user upon registration.

In a preferred embodiment, each user must register via a registration interface and pay a registration fee in order to access the investment opportunities and resources available on the platform's private website.

In order for a user to participate in the platform as a seller of an asset or investment opportunity, they must register as a seller and pay the required registration fee.

In accordance with one embodiment, the website interface includes at least a buyer interface and a seller interface.

The seller interface is configured to facilitate the seller's interactions with the platform, including the entering of information relating to the asset or share of the asset, as well as terms and conditions of the smart contract, including the monetary value of the share of the asset and the time period for which the share of the asset is to be held by the buyer. The seller also uses the seller interface to post the opportunity to acquire the share of the asset according to the terms and conditions as described in a smart contract.

In order to list the opportunity on the platform, the seller must provide all the supporting documentation that describes the asset to the platform via a seller interface on the website, where the documentation is reviewed and verified by the third party verifiers provided as part of the services provided by the platform. Upon validation, the opportunity and associated smart contract, along with all supporting documentation, are recorded on a blockchain, and are made available for viewing on the public website.

The seller interface also allows the seller to engage the buyer, including receiving an offer from the buyer for payment to acquire the asset according to the terms and conditions of the smart contract. If the terms and conditions are not deemed acceptable to the buyer, the seller may modify the terms and conditions of the smart contract to generate a modified smart contract via the seller interface.

In one embodiment, a user that would like to invest in an available opportunity is required to register and pay a registration fee in order to become a qualified buyer. Once registered, the buyer, through the buyer interface, can access the services and opportunities available on the platform through a buyer interface. The buyer interface therefore allows the buyer to access information available via the platform regarding available investment opportunities, including information relating to the asset or share of asset, as well as terms and conditions of the associated smart contract. The buyer interface also allows the buyer to engage the seller, including making an offer for payment to acquire the asset according to the terms and conditions of the smart contract, and initiate the payment process required to complete the transaction. When payment has been accepted and the transaction completed, the transaction is reviewed and validated by a third party validator and recordation on the blockchain. At the end of the time period set out in the smart contract, the share of the asset is liquidated according to the terms of the smart contract. At liquidation, the asset may be returned to the original seller or sold at an appraised market value as determined at the end of the time period.

In a preferred embodiment, the terms and conditions described in the smart contract include at least the monetary value of the share of the asset and the time period for which the share of the asset is held by the buyer. The seller can choose to monetize a portion of an asset to receive liquid capital, or sell the asset outright, according to the terms and conditions set out in the smart contract.

The seller, using the platform of the present invention, posts the investment opportunity for potential buyers, setting out the terms and conditions that apply to the investment opportunity.

In a preferred embodiment, the platform employs a distributed investment public ledger (or “blockchain”). The use of a distributed public ledger (blockchain) eliminates the fear of market tampering, stock shorting, and manipulation by bad actors, thus providing transparent, accountable, and low-risk investment opportunities, stored securely on the blockchain.

This investment platform and associated protocols allow anyone with a physical asset having monetary value to become a seller, democratizing access to investment capital, while also allowing anyone to become a buyer by providing access to investment opportunities which are more stable, easier to understand, and tied to a physical asset with a proven track record and known value. This investment platform will therefore bring a wave of new capital to the market.

The present invention also provides transparency through the use of public blockchain protocols coupled with investments in physically backed assets.

The platform of the present invention provides opportunities for investors to own shares in assets once thought to be inaccessible. The blockchain execution of smart contracts removes the need for middlemen, resulting in fewer fees for both sellers and buyers. Those who sell opportunities on the platform can now make available capital that was once locked in a physical asset, freeing up the capital to allow further investment in additional opportunities or traditional markets, while shielding investors from the problems associated with traditional investing.

The opportunities that could be made available to investors through the platform of the present invention include any type of physical asset that has monetary value according to any combination of terms and conditions as set out by the seller in the smart contract. This platform allows a company that owns such an asset to raise capital or attain bridge financing while retaining ownership of physical assets that they do not want to sell. In exchange for access to the platform and creating the applicable smart contract, the seller pays the platform administrator an upfront, non-refundable administrative fee.

The platform of the present invention can also provide an investor with the opportunity to invest in an asset that would otherwise be out of reach due to the high cost of the initial investment or the rarity of the asset in question. An exemplary asset of this type would be a Picasso painting. Ownership of such an asset is currently accessible to only a very small class of people due to the limited number of such works on the market and their associated high cost.

The platform therefore also provides an opportunity for an investor to be granted access to an investment that would not otherwise be accessible. In such a case, a share in the asset is sold to the investor for the period of time set out in the smart contract, but the physical asset would remain in the possession of the owner of the asset.

The opportunity to invest in a share of any type of physical asset can be made available to an investor through the platform of the present invention. For example, by listing an opportunity, a developer or farmer can list an extensive land holding, a mining company could list deposits that sit untouched, manufacturers could list product stock or raw materials. By listing their assets on the platform, companies can benefit from the liquid capital locked in their assets, while allowing investors to buy shares and profit from the increasing valuation. At the end of the term of the smart contract, companies can use the increased valuation of their assets to pay out the shareholders. This increases access to capital for companies now, while allowing them to retain their assets for future development.

The platform of the present invention thus provides the seller the ability to continue to own and enjoy their assets, while monetizing at least a portion of the capital that it represents.

By posting the investment opportunities to multiple interested parties on a distributed public ledger, the platform also provides the possibility of accelerating the rate of increasing valuation, as more buyers are able to compete for access to shares in the asset.

For example, a land developer who purchases large swathes of land in anticipation of the growth of cities and towns is often left holding these assets for decades before they are in a position to develop, which can take an expensive toll on the company. By offering their land holdings on the platform, the land developer is able to make available a portion of the capital tied up in the land while retaining ownership. For example, by allowing a buyer to invest in a share of the land holdings over the term of a 20 year smart contract, the platform of the present invention can provide the developer with access to working capital over the duration of the contract, while also providing the buyer access to a share in the increase of value of the land over that time period.

In those embodiments where the terms and conditions of the smart contract preclude the sale of the opportunity before expiry of the contract term, the smart contract may include provisions to allow the investor to trade the smart contract on an exchange. By allowing an investor to trade or sell their smart contract, the investor is provided an opportunity to gain some liquidity without breaking the terms and conditions of the smart contract.

In one embodiment, a buyer of an opportunity is able to trade their stake in the asset at any time, and at the end of the term of the smart contract, the asset would return to the sole ownership of the company, having provided returns for investors and working capital for the company during the contract term.

For example, a mining company could raise money in a non-dilutive manner by making half of their mineral reserve an opportunity on the platform for a ten year term. With the money that they are able to raise, based on the value of their reserve, they could then open a new mine or fund an ongoing project. In one embodiment, buyers of the opportunities are able to trade their stake in the reserve at any time, and at the end of the term, the mineral reserve would return to the sole ownership of the company, having provided returns for investors and working capital for the company during the 10 year term of the contract.

As a further example, a Picasso that is passed down through a family for generations is an example of an asset that may have a value goes beyond its monetary value to include the emotional connection to the piece. Although the family may not want to part with the painting, they may find themselves needing liquid capital. The platform of the present invention would allow the family to sell one or more shares in the painting to interested investors. These shares are likely to appreciate due to the increased investor access to the asset, while also allowing the seller to enjoy the benefits of the liquidity. The buyer benefits by purchasing a stake in an asset that may otherwise be out of reach.

In yet another example, families could also use the platform for estate planning. By creating smart contracts while still alive, families could charge a nominal fee to sell stakes in an asset to their family members. This would allow stakes in the asset to pass to the family members, free from estate taxes, as the contract would have been effectuated while the family member was still living. This solution would also keep family infighting to a minimum as shares in family assets would be determined before death.

The platform of the present invention is therefore an investment platform that provides buyers/investors with access to highly secure, transparent, and low-risk investment opportunities relating to physical assets that have historically provided a more steady return and rarely experience depreciation and as they are backed by an asset it also mitigates the level of complete loss when in comparison to an organization that can go bankrupt.

By selling shares in physical assets, an investor may also avoid many of the pitfalls associated with traditional investing, for example, by eliminating ongoing management fees, thus reducing the barrier to entry for novice investors or investors with limited capital to invest.

Accordingly, the present invention provides a method for monetizing a wide variety of physical assets. Once a suitable physical asset has been identified, the monetary value of a share of the asset is determined. In one embodiment, the share of the asset is a portion of the asset, wherein the seller retains legal title to the asset, but sells shares of a predetermined percentage of the asset. In another embodiment, the share of the asset is the entire asset.

The present method further comprises the step of posting or advertising, by the seller, an opportunity for a buyer to acquire the share of the asset according to terms and conditions as described in a smart contract attached to the opportunity, wherein the terms and conditions described in the smart contract include at least the monetary value of the share of the asset and the duration for which the share of the asset will be held by the buyer. The attached contract represents the terms of an agreement that the seller is willing to enter into with a willing buyer based on the posted opportunity. At this stage, it is equivalent to the contract being signed only by the seller.

A potential buyer, using the platform of the present invention, is then able to access a summary of the available opportunities and the applicable smart contracts outlining the terms and conditions of the contractual relationship between buyer and seller.

If the buyer decides to participate, they deposit payment into an escrow account. Once all shares available as part of the opportunity are purchased, the payment(s) would transfer from the escrow account to the seller. The present platform and associated protocols track the delivery of the payment(s) into the seller's account.

Accordingly, in one embodiment, a payment from the buyer is first deposited into an escrow account pending acceptance of the payment by the seller.

In one embodiment, payments are made using fiat currency. In one embodiment, payments are made using cryptocurrency, such as Ethereum. In one embodiment, payments are made using a combination of fiat currency and cryptocurrency.

The terms set out by the seller are accepted by the buyer once payment has been made. Once the payment is transferred, the smart contract is completed between the seller and buyer and is recorded on the relevant opportunity blockchain. At this stage, the smart contract becomes effective in accordance with the terms and conditions established by the seller in the smart contract.

The present method therefore further comprises a step of accepting payment from the buyer to effect the transfer of the share in the asset from the seller to the buyer.

In a preferred embodiment, when payment has been accepted and the transaction completed, the transaction is reviewed and validated by a third party validator prior to recordation on the blockchain.

Accordingly, an investor is provided with an opportunity to invest in a specific physical asset by dealing directly the asset owner and carrying out all steps of the transaction via the platform of the present invention, without incurring additional costs associated with engaging a middleman or intermediary bureaucracy to broker the transaction. Thus, any financial outlay made by the investor can be converted directly into an investment in the asset.

An additional benefit is that, by investing directly in the asset itself, the investor is able to bypass any “business risk” associated with investing through a company, for example, as a result of mismanagement or excessive management fees.

In one embodiment, a verification process takes place when assets are to be added to the platform. For example, sellers would be required to complete a legal form confirming their ownership of the asset including all required proofs, and/or a third party verifier such as a legal professional would be engaged to perform due diligence and confirm the existence of the asset and that the seller indeed has title to the asset. Once the seller's asset is legally verified, it can be added to the platform of the present invention as an opportunity.

Accordingly, in one embodiment, the method of the present invention further comprises a step of verifying that the asset exists, wherein the verification step is carried out by a third party.

In another embodiment, the method of the present invention further comprises a step of verifying that the first party has title to the asset, wherein the verification step is carried out by a third party.

The services of third party verifiers are made available to the seller and buyer as part of the protocol. Third party verifiers are allowed to participate in the verification process upon payment of a referral fee.

Once the smart contract is fully implemented, the seller may be charged a non-refundable completion fee that is paid by the seller to the administrator of the platform. In one embodiment, the completion fee reflects a percentage of the purchase price for each opportunity, paid to the administrator pursuant to the deployment of the smart contract. In such an embodiment, the completion fee reduces the purchase price received by the seller for the opportunity they provided, and may be paid directly from the escrow account.

In one embodiment, the seller pays an upfront administrative fee to the administrator of the platform for access to the platform.

Each opportunity, represented by the attached smart contract, is recorded on a separate blockchain. This blockchain acts as a public ledger to register the opportunity and records all transactions implemented. Once the smart contract is written, the opportunity becomes available on the platform, as an opportunity blockchain. With each new smart contract, a new opportunity blockchain is added to the platform. The platform can therefore be used to create concurrent opportunity blockchains that provide investment access to assets that were once extremely difficult to monetize.

Under the terms of each smart contract, title to the asset provided by the seller may be transferred to the buyer outright or the buyer may acquire a stake in the asset that will allow them to participate in the increased or decreased valuation of the asset. The transaction between seller and buyer is captured in the smart contract which lives on the applicable opportunity blockchain.

In one embodiment, a secondary market may be created on the platform. Buyers of assets would be able to sell the terms and conditions of their smart contract to another potential buyer at a price they choose. This creates a new speculative marketplace where savvy investors can make significant gains by understanding the conditions of the marketplace. Allowing investors to trade and sell their smart contracts provides the investor with flexibility to modify the terms of their investment or allow them to escape their investment obligation when they please.

The use of blockchain technology to act as a distributed public ledger creates a layer of trust and accountability that will put users at ease. By leveraging the blockchain, all transactions are recorded in an easily accessible public ledger. This transparency is a key element to gaining the confidence and trust of users. With all transactions recorded publically, there is no chance for individuals or groups to manipulate the market. It also eliminates any potential access advantages that currently favour large investment groups and hedge fund operators.

Beyond the transparency, blockchain provides a level of security that is essentially unhackable. By connecting block after block into one continuous chain, a hacker would need to change the block, or record, that they are targeting, as well as every other block attached to it. Even if they were able to do this, records stored on the blockchain are secured using cryptography. The personal keys assigned to each user act as a digital signature. If a record is altered, the signature becomes invalid and the entire peer network is notified that something has happened. And if that wasn't enough, blockchains are distributed across networks of computers, making a single, central point of attack impossible. The more blocks that are added to the chain, the more secure they are. This is another selling point to attract mass adoption.

The present invention therefore employs a blockchain infrastructure that utilizes specialized cryptographic protocols for securely creating, trading, clearing, settling and authenticating transactions associated with the present methods for monetization of a physical asset. The platform of the present invention is a web-based or cloud-based platform that is accessible over a network using computing devices operated by users (e.g., issuers/sellers, investors/buyers, administrators or other users). The users may download and install the platform on the computing devices. The platform enables the users to access a distributed, peer-to-peer network utilizing blockchain technology in various ways to facilitate transactions. Interfaces provided by the platform enable the users to perform trade-related functions (e.g., such as posting information regarding opportunities for investment in an asset, and issuing and accepting payment for the asset).

The peer-to-peer network utilizes a public or private blockchain which includes a ledger (also referred to as a “blockchain ledger”) that is distributed among the computing devices on the network. In certain embodiments, the network utilizes a private, permission-based blockchain that is available to users who have downloaded and registered with the platform. When an issuer or other user creates a new opportunity, the opportunity and its associated data are stored directly on the ledger itself and are represented as one or more entries (or “blocks”) on the blockchain.

For each opportunity that is created, the blockchain may be appended with an entry that includes a dataset that represents the opportunity itself. An exemplary dataset may include any data or information that is relevant to the opportunity including, but not limited to, data that identifies the type of asset, the issuer/seller, regulatory rules and restrictions that apply to the transfer of the asset, documentation pertaining to the asset, ownership data, and other related information. In certain embodiments, some or all of the dataset associated with the opportunity (including related files or documentation) may be stored on a server and the entry in the blockchain corresponding to the security may include a key or cypher than enables the data to be unlocked and retrieved. Once an opportunity is created, potential investors can access the system to obtain comprehensive and detailed information pertaining to all available opportunities, thus providing investors with the information necessary to make decisions regarding possible transactions.

The platform may include specialized cryptographic protocols which are employed to update the blockchain ledger and exchange virtualized data tokens in order to facilitate trading and authenticating of opportunities. The blockchain ledger provides an audit trail that can be utilized in real-time to track and validate all transactions involving the data tokens. All transactions, including previous transactions that resulted in an exchange of an asset, can be self-verified instantly using the audit trail provided by the blockchain, thus providing a high level of transparency and protection to all interested individuals.

The virtual data tokens may include embedded data that travels with the tokens throughout their lifecycle, starting with the initial issuance of the opportunity and continuing as the asset is transferred. Some or all of the embedded information may also be recorded on the distributed blockchain ledger that is maintained by network. The embedded information may include any data associated with any transaction involving the asset, any parties to the transactions, and/or any data about the asset itself. Instead of embedding large documents (or an impractically large amount of data) into the virtual data tokens, the tokens may include a key or cypher that is used to unlock and securely access the documents (e.g., which may be stored on the cloud-based portion of the platform). The system is able to process transactions quickly and efficiently because a centralized banking institution is not required to perform clearance and settlement functions. Furthermore, because the record keeping or auditing process for all transactions is “dematerialized” (e.g., conducted and stored electronically without need for physical papers or handwritten signatures), all of the relevant documentation is immediately available to interested parties.

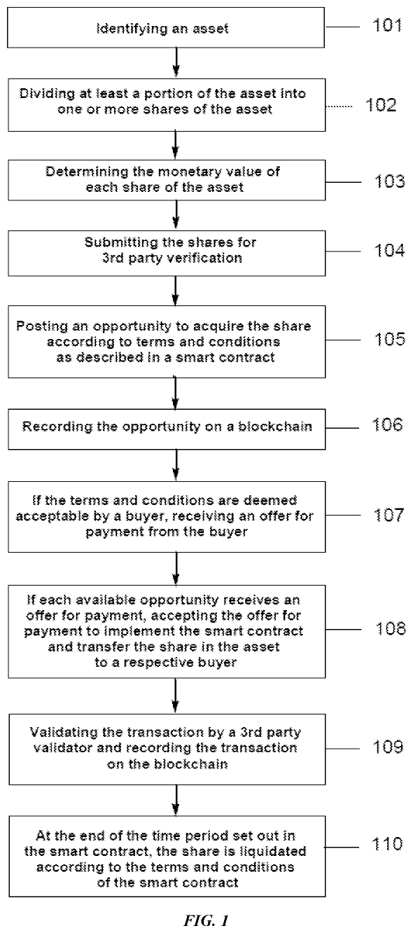

FIG. 1 is a flow chart describing one embodiment of the method of the invention, in which a transaction is initiated by a seller, who identifies an asset (Step 101), divides at least a portion of the asset into one or more shares of the asset (Step 102), and determines the monetary value of each share of the asset (Step 103). The shares are then submitted for verification by a third party verifier (Step 104). The seller then posts an opportunity to acquire the share of the asset according to terms and conditions as described in a smart contract (Step 105), and the opportunity is recorded on a blockchain (Step 106). If the terms and conditions are deemed acceptable by a buyer, the buyer proceeds by issuing an offer for payment to the seller (Step 107). If each available opportunity receives an offer for payment, the seller accepts the payment offers to implement the smart contract and transfer the share(s) in the asset (Step 108). Once the transaction is complete, it is validated and recorded on the blockchain (Step 109). At the end of the time period set out in the smart contract, the share of the asset is liquidated according to the terms and conditions of the smart contract (Step 110).

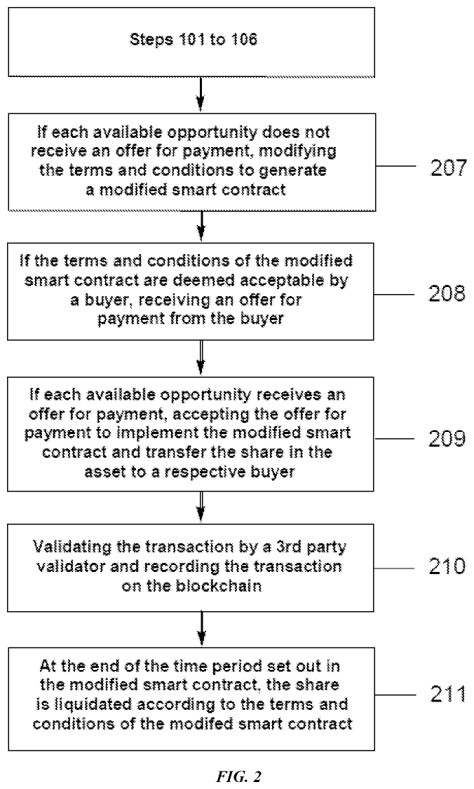

FIG. 2 is a flow chart describing another embodiment of the method of the invention, in which, following Steps 101 to 106 as outlined in FIG. 1, each available opportunity does not receive an offer for payment. In this embodiment, the seller modifies the terms and conditions of the smart contract to generate a modified smart contract (Step 207). If the terms and conditions of the modified smart contract are deemed acceptable by a buyer, the buyer proceeds by issuing an offer for payment to the seller (Step 208), and if each available opportunity receives an offer, the seller accepts the payment offers to implement the modified smart contract and transfer the share(s) in the asset (Step 209). Once the transaction is complete, it is validated and recorded on the blockchain (Step 210). At the end of the time period set out in the modified smart contract, the share of the asset is liquidated according to the terms and conditions of the modified smart contract (Step 211).

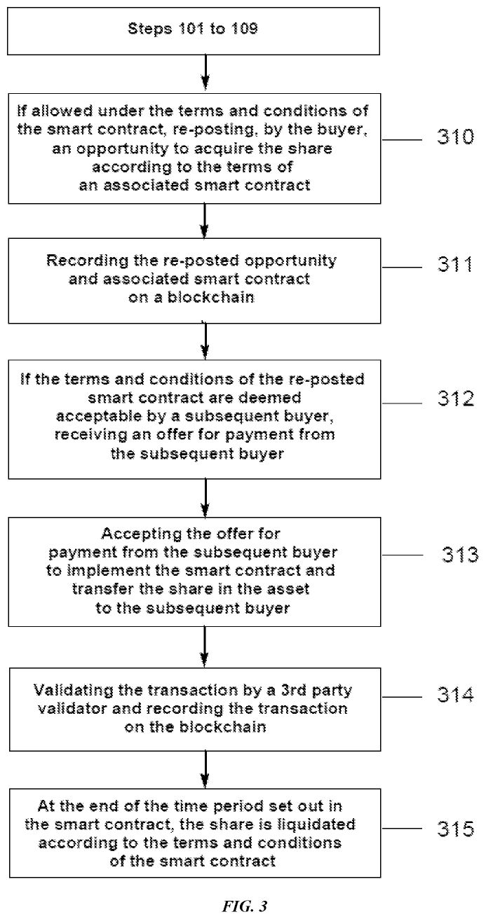

FIG. 3 is a flow chart describing another embodiment of the method of the invention, in which, following Steps 101 to 109 as outlined in FIG. 1, the original buyer of the share re-posts via the platform an opportunity for subsequent buyers to acquire the share according to the terms and conditions of an associated smart contract (Step 310). The re-posted opportunity and associated smart contract are recorded on a blockchain (Step 311). If the terms and conditions of the re-posted smart contract are deemed acceptable by a subsequent buyer, the subsequent buyer proceeds by issuing an offer for payment to the original buyer (Step 312). If the original buyer accepts the payment offer, the smart contract and transfer is implemented to transfer the share to the subsequent buyer (Step 313). Once the transaction is complete, it is validated and recorded on the blockchain (Step 314). At the end of the time period set out in the smart contract, the share of the asset is liquidated according to the terms and conditions of the smart contract (Step 315).

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will be understood that each step in the methods of the present invention may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the method steps.

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the method steps.

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the method steps. Alternatively, computer-implemented steps may be combined with, and/or replaced with, operator- and/or human-implemented steps in order to carry out an embodiment of the present invention.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

We claim:

1. A method for monetizing a physical asset owned by a seller using an Internet-based platform accessible via a website interface configured to facilitate a transaction between the seller and at least one buyer, the method comprising the steps of:
identifying an asset, dividing at least a portion of the asset into one or more shares of the asset, and determining a monetary value of each of the one or more shares of the asset;
submitting the one or more shares for verification by a third party verifier;
posting an opportunity for each of the one or more shares, wherein the opportunity is an offer for a buyer to acquire one of the one or more shares of the asset according to terms and conditions as described in a smart contract, each said opportunity being posted by the seller via a seller interface on the website, each said opportunity and associated smart contract being recorded on a blockchain;
if the terms and conditions of the smart contract are deemed acceptable by the buyer, receiving an offer for payment from the buyer, the offer for payment being entered by the buyer via a buyer interface on the website;
if each available opportunity receives an offer for payment, accepting each said offer for payment from each respective buyer to implement the smart contract and transfer a respective share in the asset to the respective buyer, the offer being accepted by the seller via the seller interface to complete the transaction according to the terms and conditions of the smart contract; and
validating the transaction by a third party validator and recording the transaction on the blockchain;
wherein the terms and conditions described in the smart contract include the monetary value of the share of the asset and the time period for which the share of the asset is held by the buyer, and wherein at the end of the time period, the share of the asset is liquidated according to the terms and conditions of the smart contract.

2. The method of claim 1, wherein if each available opportunity does not receive an offer for payment, the method further comprises the steps of:
modifying the terms and conditions of the smart contract for acquisition of the one or more shares of the asset to generate a modified smart contract, the modifications being made by the seller via the seller interface; and
if the terms and conditions of the modified smart contract are deemed acceptable by a buyer, receiving an offer for payment from the buyer, the offer for payment being entered by the buyer via the buyer interface; and
if each available opportunity receives an offer for payment, accepting each said offer for payment from each respective buyer to implement the modified smart contract and transfer a respective share in the asset to the respective buyer, the offer being accepted by the seller via the seller interface to complete the transaction according to the terms and conditions of the modified smart contract; and
validating the transaction by a third party validator and recording the transaction on the blockchain.

3. The method of claim 1 or 2, wherein the one or more shares of the asset comprise the entire asset.

4. The method of claim 1 or 2, wherein the one or more shares of the asset comprise a portion of the asset.

5. The method of claim 1 or 2, wherein the liquidation of the share of the asset comprises sale back to the original seller.

6. The method of claim 1 or 2, wherein the liquidation of the share of the asset comprises sale to a third party purchaser.

7. The method of claim 1 or 2, wherein the opportunity is posted on a distributed public ledger.

8. The method of claim 1 or 2, wherein the verification comprises verifying the monetary value of the share of the asset.

9. The method of claim 1 or 2, wherein the verification comprises verifying that the asset exists.

10. The method of claim 1 or 2, wherein the verification comprises verifying that the seller has title to the asset.

11. The method of claim 1 or 2, further comprising a step of verifying the appraised market value of the share of the asset at the end of the time period, wherein the verification step is carried out by a third party appraiser.

12. The method of claim 1 or 2, wherein the payment is initiated by the buyer using the buyer interface.

13. The method of claim 12, wherein the payment from the buyer is first deposited into an escrow account pending acceptance by the seller.

14. The method of claim 12, wherein the payment is made in fiat currency.

15. The method of claim 12, wherein the payment is made in cryptocurrency.

16. The method of claim 1, further comprising the steps of:
if the terms and conditions of the smart contract allow, re-posting, by the original buyer, an opportunity to acquire the at least one share by purchase or trade according to terms and conditions as described in an associated smart contract, the re-posted opportunity being posted by the original buyer via the seller interface on the website, the re-posted opportunity and associated smart contract being recorded on the blockchain;
if the terms and conditions of the re-posted smart contract are deemed acceptable by a subsequent buyer, the subsequent buyer proceeds by issuing an offer for payment to the original buyer via the buyer interface on the website;
if the original buyer accepts the payment offer, implementing the smart contract to transfer the share to the subsequent buyer, the offer being accepted by the original buyer via the seller interface to complete the transaction according to the terms and conditions of the re-posted smart contract; and
validating the transaction by a third party validator and recording the transaction on the blockchain.

17. A system for monetizing a physical asset owned by a seller, wherein the system comprises:
a memory;
a communication interface;
one or more processors; and
executable code stored in memory, wherein the code, when executed by the one or more processors, causes the one or more processors to carry out the method as defined in any one of claim 1 or 2.

18. A computer program product comprising a computer readable memory storing computer executable instructions thereon that when executed by a computer perform the method as defined in any one of claim 1 or 2.
